(19) United States
(12) Patent Application Publication
(10) Pub. No.: US 2020/0364676 A1
(43) Pub. Date: Nov. 19, 2020

(54) SYSTEMS AND METHODS FOR DETERMINING DISPOSITION PATHS

(71) Applicant: Walmart Apollo, LLC, Bentonville, AR (US)

(72) Inventors: Maheer Manmohan, Newark, CA (US); Daniel J. Eckert, Rogers, AR (US); Mark W. Matthews, Rogers, AR (US); Timothy H. Chui, Foster City, CA (US); Kurt W. Templeton, Bentonville, AR (US); Robel D. Lakwe, Silver Spring, MD (US); Andrea B. Shoppach, Cave Springs, AR (US); Ting Li, Bentonville, AR (US); Willie Montgomery, III, Rogers, AR (US); Jeremy Shoblom, Bentonville, AR (US); Charls Christo Irus Antony, Bentonville, AR (US); Jaclyn M. Lomax, Rogers, AR (US); Adam Stewart Underwood, Fayetteville, AR (US); Tensae A. Beyene, Aldie, VA (US); Mikiyas Teshome Workeneh, Reston, VA (US); Douglas E. Humphrys, Bentonville, AR (US); Brian M. Stoll, Reston, VA (US); Nivea Mandavia, Sterling, VA (US); Michael Carey, Chantilly, VA (US); Yiyi Zeng, San Jose, CA (US)

(21) Appl. No.: 15/931,235

(22) Filed: May 13, 2020

Related U.S. Application Data
(60) Provisional application No. 62/847,039, filed on May 13, 2019.

(51) Int. Cl. G06Q 10/00; G06Q 10/08

(52) U.S. Cl. CPC G06Q 10/30; G06Q 30/012; G06Q 10/087

(57) ABSTRACT

In some embodiments, apparatuses and methods are provided herein useful to determining a disposition path for a returned item. In some embodiments, a system comprises a database including item-specific data for a plurality of items and customer data for a plurality of customers, a control circuit configured to determine a suggested disposition path for each of the items, transmit the suggested disposition path for each of the plurality of items, and a user device configured to receive, from a user, a return initiation including an indication of an item and a customer, and transmit the return initiation, wherein the control circuit is further configured to receive the return initiation, determine a trust score for the customer, determine a suggested disposition path for the item, determine, based on the trust score and the suggested disposition path, a disposition path for the item, and transmit an indication of the disposition.

### CROSS-REFERENCE TO RELATED APPLICATION

This application claims the benefit of U.S. Provisional Application No. 62/847,039, filed May 13, 2019, which is incorporated by reference in its entirety herein.

### Technical Field

This invention relates generally to retail sales and, more specific, returns of items purchased via a retail sale.

### BACKGROUND

Generally, the larger the sales volume for a retailer the larger the return volume the realter will experience. The cost for returning items is not insignificant for retailers. For example, the retailer may pay shipping fees for a customer to return an item, incur costs to restock items or mark items down, and incur costs to transport products to return centers. While these costs may be somewhat small on an item-by-item basis, these costs can become quite substantial when return volume is high.

Typically, retailers simply have customers return unwanted items and the employee handling the return decides what should be done with the items once they are returned. While this system works to process returns, it may not always result in the highest value option being chosen for the retailer, thus resulting in costs and/or losses for the retailer. Consequently, a need exists for better systems and methods for determining disposition paths for returned items.

### BRIEF DESCRIPTION OF THE DRAWINGS

Disclosed herein are embodiments of systems, apparatuses, and methods pertaining to determining a disposition path for a returned item. This description includes drawings, wherein:

FIGS. 1A and 1B depict user devices, 102 and 108 respectively, presenting dispositions paths, 106 and 112 respectively, for a returned item, according to some embodiments;

FIG. 2 is a chart 200 depicting possible disposition paths for returned items, according to some embodiments;

FIG. 3 is a block diagram of a system for determining a disposition path for a returned item, according to some embodiments; and

FIG. 4 is a flow chart including example operations for determining a disposition path for a returned item, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to determining a disposition path for a returned item. In some embodiments, a system for determining a disposition path for a return item comprises a database, wherein the database includes item-specific data for a plurality of items and customer data for a plurality of customers, wherein the item-specific data for a plurality of items includes reverse supply chain cost information and suggested disposition paths, and wherein the reverse supply chain cost information includes one or more of probability of resale, markdown for resale, retail price, cost of product, store handling cost, liquidation recovery, return center handling cost, store to return center transportation cost, margin, tax rate, other cost, cost of product, and customer service desk cost, a control circuit, wherein the control circuit is configured to determine, based on the reverse supply chain cost information, a suggested disposition path for each of the plurality of items, and transmit, to the database for storage, the suggested disposition path for each of the plurality of items, and a user device including a user input device, wherein the user device is configured to receive, via the user input device from a user, a return initiation, wherein the return initiation includes an indication of an item and an indication of a customer, and transmit, to the control circuit, the return initiation, wherein the control circuit is further configured to receive, from the user device, the return initiation, determine, based on the indication of the customer and the customer data for a plurality of customer, a trust score for the customer, determine, based on the indication of the item and the item-specific data, a suggested disposition path for the item, determine, based on the trust score for the customer and the suggested disposition path for the item, a disposition path for the item, and transmit an indication of the disposition path for the item.

As previously discussed, the cost of returned items is not insignificant to retailers. Even if the retailer simply puts a returned item back on the shelf for sale, the retailer still incurs some cost to process the return and get the item back on the shelf. Additionally, if the item takes another disposition path (e.g., the item is donated, marked down, etc.), the retailer may incur even greater costs. However, there isn't a simple answer for “what to do with an item.” Assuming that the goal is to incur as low of a cost as possible when processing a return, the answer (i.e., what is the appropriate disposition path) is likely item-specific and depends on a number of factors. Additionally, some returned items may be more difficult to sell than others and may require a discount. For example, a retailer may not be able to sell returned produce and may have to offer a discount on a returned electronics item in order to sell it.

Described herein are systems, methods, and apparatuses that determine disposition paths for items. In some embodiments, a system calculates costs associated with each possible disposition path for items sold by the retailer. The disposition paths are then ranked from most to least cost effective. In some embodiments, the goal is to determine the most cost-effective disposition path for every item that a retailer sells in an effort to minimize costs to the retailer. In such embodiments, when a return is initiated, an employee and/or a customer are presented with the appropriate disposition path for the item.

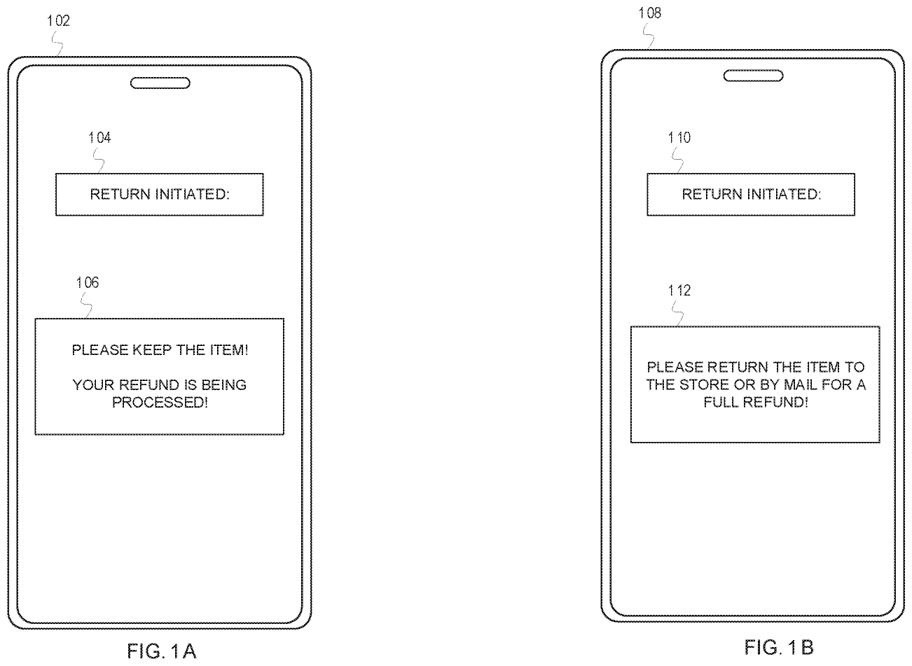

FIGS. 1A and 1B depict user devices, 102 and 108 respectively, presenting dispositions paths, 106 and 112 respectively, for a returned item, according to some embodiments. In the example depicted in FIGS. 1A and 1B, a customer has initiated a return from his or her user device 102, 108, as indicated by return initiation indicators 104, 110. For example, the customer may be initiating a return for an item purchased at a retailer (e.g., a brick-and-mortar retailer) or ordered online. When the customer initiates the return, a disposition path for the return is presented.

In the example depicted in FIG. 1A, the disposition path 106 is for the customer to keep the item. In this example, it may cost more for the retailer to process the return than it would to have the customer simply keep the item. In this case, the customer is refunded his or her money. Similarly, the retailer may offer the customer a partial return and allow the customer to keep the item, assuming the customer agrees to this proposition. For example, if the customer ordered a set of eight glasses online and discovered that two were damaged upon arrival, the disposition path may be for the customer to keep the item (i.e., the eight glasses) and offer the customer a partial refund (i.e., a “discount”) on the purchase of, for example, 50% off. In some embodiments, the customer is only permitted to keep the item if the customer has a trust score above a threshold. For example, if it is determined that customer is not likely to be attempting to defraud the retailer and the disposition path for the item is for the customer to keep the item, the customer may be permitted to keep the item. Alternatively, if the customer has a trust score below the threshold and the disposition path is for the customer to keep the item, an alternative disposition path may be selected (e.g., asking the customer to return the item).

In the example depicted in FIG. 1B, the disposition path 112 is for the customer to return the item. For example, the customer may return the item by mailing it back or bringing it to the retail facility. This disposition path 112 may be selected for items in which the cost of processing the return is less than allowing the customer to keep the item. For example, a retailer may be able to resell and expensive television for the full retail price. If the retailer allows the customer to keep it, the retailer would incur a substantial cost and lose the opportunity to resell the expensive television.

While the example depicted in FIGS. 1A and 1B include disposition paths being presented via a customer's user device, embodiments are not so limited. For example, when a customer returns a product to a retail facility, a device (e.g., a point-of-sale (“POS”) terminal) may present the disposition path to the employee.

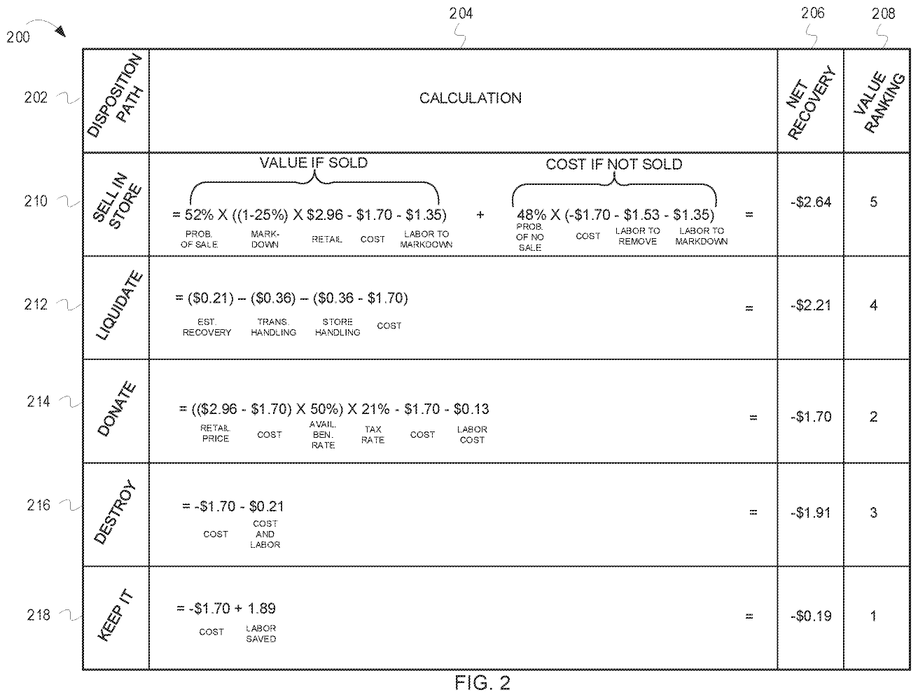

While the discussion of FIGS. 1A and 1B provide an overview of return initiation and disposition paths, the discussion of FIG. 2 provides additional detail regarding possible disposition paths for a returned item.

FIG. 2 is a chart 200 depicting possible disposition paths for returned items, according to some embodiments. The chart 200 includes five disposition paths: 1) sell in store 210, 2) liquidate 212, 3) donate 214, 4) destroy 216, and 5) keep it 218. The chart 200 also includes a calculation section 204 showing an example calculation for each disposition path, a net recovery section 206 showing example costs to the retailer, and a value ranking section 208 showing a ranking of each of the possible disposition paths based on the net recovery section 206. Each of the possible disposition paths will be discussed in turn. In the examples depicted in FIG. 2, the same item is being analyzed. That is, the net recovery for each disposition path for an item is being calculated.

The sell in store 210 disposition path is a cost to the retailer of returning the item and selling the item in the store. As one example, the formula for the sell in store 210 disposition path is:

Recovery=value if sold−cost if not sold;

where

Value if sold=probability of sale×((1−markdown)×retail price−cost−labor to markdown)

and

Cost if not sold=probability of no sale×(cost−labor to remove−labor to markdown)

At a high level, this calculation considers historically how likely a specific item is to sell if it is replaced on the floor for sale and whether the item will need to be marked down in order for it to sell. The calculation uses a weighting based on these probabilities to determine a cost associated with selling an item in the store. In the example provided in FIG. 2, the probability that the item will sell in the store is 52%. Accordingly, the probability that the item will not sell in the store is 48%. The retail value of the item (i.e., the “regular” price of the item) is $2.96, the cost of the item (i.e., how much the retailer paid for the item) is $1.70, and the labor cost to mark the item down is $1.35. As for the cost if not sold portion of the equation, the labor to remove the item if it does not sell is $1.53. The result of this equation is that, on average, it will cost the retailer $2.64 to process this specific item with the sell in store 210 disposition path.

The liquidate 212 disposition path is a cost to the retailer if the item is liquidated. For example, this may be the cost if the product is sent to a return center and/or to the supplier for a refund. As one example, the formula for the liquidate 212 disposition path is:

Recovery=estimated recovery−transaction Handling−store handling−cost

At a high level, this calculation considers all costs incurred with liquidating the item. In the example depicted in FIG. 2, the estimated recovery for the item (i.e., the liquidation value of the item) is $0.21, the transaction handling costs are $0.36, the store handling cost is $0.36, and the cost of the item is $1.70. The result for this equation is that, on average, it will cost the retailer $2.21 to process this specific item with the liquidate 212 disposition path.

The donate 214 disposition path is a cost to the retailer if the item is donated. For example, if a product has a low likelihood of resale or would require a significant markdown and the retailer is eligible to receive a tax credit if the item is donated, the retailer may choose to donate the item. As one example, the formula for the donate 214 disposition path is:

Recovery=((retail price−cost)×rate)×tax rate−cost−labor cost

At a high level, this calculation considers the cost benefits of donating the item versus the cost to the retailer of not selling the item. This calculation considers the retail price of the item, the cost of the item, a rate (e.g., a benefit rate), a tax rate, and the labor cost to donate the item. The result of this equation is that, on average, it will cost the retailer $1.70 to donate the item.

The destroy 216 disposition path is a cost to the retailer of destroying or otherwise disposing of the item. For example, some items may not be able to be resold, donated, etc. Consequently, the retailer may be forced to destroy or otherwise dispose of the item. As one example, the formula for the destroy 214 disposition path is:

Recovery=cost−labor costs

At a high level, this calculation considers the cost to the retailer is the retailer is to destroy the item. In this scenario, the cost of the item to the retailer must be considered as well as the actual cost to destroy the item. While the cost to destroy the item in example provided in FIG. 2 is quite low, it should be noted that if the item contains hazardous material (e.g., fertilizer) or must otherwise be disposed of properly, this cost can be quite high. The result of this equation is that, on average, it will cost the retailer $1.91 to destroy the item.

The keep it 218 disposition path is a cost to the retailer if the customer is allowed to keep the item and receive a refund. For example, if the item is relatively inexpensive (i.e., like the item in the example provided in FIG. 2), it may be most cost effective for the retailer to allow the customer to keep the item and provide the customer with a refund. As one example, the formula for the keep it 218 disposition path is:

Recovery=cost+labor saved

At a high level, this calculation considers the cost of the item in relation to the cost savings that the retailer will realize by not processing the return. The result of this equation is that, on average, it will cost the retailer $0.19 to allow the customer to keep the item.

As can be seen from the net recovery section 206 of the chart 200, for the particular item considered in the example of FIG. 2, the lowest cost disposition path for the retailer is the keep it 218 disposition path. That is, all of the other disposition paths will cost the retailer more money than simply allowing the customer to keep the item and providing the customer with a refund. The value ranking section 208 depicts the rankings of each of the disposition paths relative to one another.

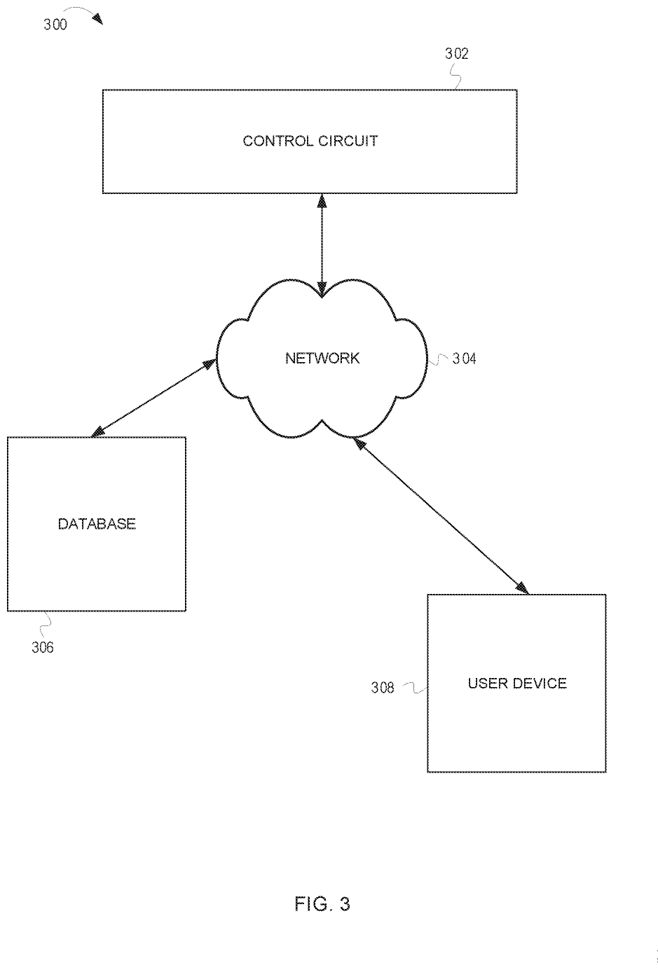

While the discussion of FIG. 2 provides an example of disposition paths for a specific item, the discussion of FIG. 3 describes a system for determining disposition paths for a number of items.

FIG. 3 is a block diagram of a system for determining a disposition path for a returned item, according to some embodiments. The system 300 is operable to determine disposition paths for returned items. In one embodiment, the system 300 determines suggested disposition paths for all items that a retailer sells. The suggested disposition paths are determined based on the cost of the possible disposition paths for the items. Additionally, in some embodiments, the system 300 determines disposition paths for specific items when a return is initiated. For example, the system 300 considers the suggested disposition path for the item and other factors to determine if the disposition path in that specific instance should be the suggested disposition path for the item or an alternate disposition path for the item.

The system 300 includes a control circuit 302, a database 306, and a user device 308. The control circuit 302, the database 306, and user device 308 are communicatively coupled via a network 304. The network 304 can be of any suitable type and include a wide area network (“WAN) such as the Internet and/or a local area network (“LAN”).

The database 306 includes customer data for a plurality of customers. For example, the customer data can include a customer's purchase history, return history, browser activity, purchasing trends, return trends, etc. In some embodiments, the customer data is used to determine a trust score for the customer. The trust score is an indication of the likelihood that a customer's return is valid and in good faith. The control circuit 302 determines trust scores for customers.

The database 306 also includes items-specific data for items that the retailer sells. For example, the database 306 includes item-specific data for items that the retailer sells in brick-and-mortar facilities and/or online. The item-specific data for the items includes reverse supply chain cost information and suggested disposition paths for each of the items. For example, the reverse supply chain cost information can include probability of resale, markdown for resale, retail price, cost of product, store handling cost, liquidation recovery, return center handling cost, store to return center transportation cost, margin, tax rate, other cost, cost of product, customer service desk cost, etc. The suggested disposition paths for the items are determined by the control circuit 302.

The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 302 operably couples to a memory. The memory may be integral to the control circuit 302 or can be physically discrete (in whole or in part) from the control circuit 202 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

In some embodiments, the control circuit 302 determines suggested disposition paths for all items that a retailer sells. For example, the control circuit 302 can determine the suggested disposition paths for all items that retailer sells in brick-and-mortar facilities and/or online. The control circuit 302 determines the suggested disposition paths for the items based on the reverse supply chain cost information in the database 306. In some embodiments, the suggested disposition path for each item is the disposition path that results in the highest value (i.e., the lowest cost) to the retailer. By determining suggested disposition paths for each of the items, the highest value disposition path will be provided to, for example, an employee when he or she processes a return to increase the likelihood that the correct disposition path is selected for the item. The control circuit 302 stores the suggested disposition paths for the items in the database 306.

When a customer initiates a return, the control circuit 302 determines a disposition path for the item(s) associated with the return initiation. In one embodiment, the disposition path for the item is simply the suggested disposition path. That is, when a return is initiated, the control circuit 302 determines the disposition path for the item by accessing the database 306 and retrieving the suggested disposition paths.

However, in some embodiments, the control circuit 302 can consider additional information when determining the disposition path for the item. For example, the control circuit 302 can consider the conditions surrounding the return and the customer information associated with the customer (e.g., based on an indication of the customer and the item included in the return initiation). As one specific example, the control circuit 302 can consider a trust score for the customer. The control circuit 302 can determine the trust score for the customer based on the customer data stored in the database 306. In some embodiments, one goal of the trust score is to help prevent the retailer's return policy from being taken advantage of For example, if a customer typically buys low value items, returns those items, and is allowed to keep those items, a pattern may be developing that the customer buys low value products with a goal of receiving a refund without returning the item. Conversely, if a customer has a low return to purchase value, when the customer initiates a return it is likely not an attempt to take advantage of the retailer's return policy. The control circuit 302 can calculate the trust score based on any suitable factors, such as purchase history, return history, purchasing trends, return trends, etc.

In embodiments in which additional factors, such as a trust score for a customer, are used to determine a disposition path for an item, the control circuit 302 may determine that the disposition path for the item differs from the suggested disposition path. For example, if the suggested disposition path for an item is keep it but the customer's trust score is below the threshold, the control circuit 302 may determine that the disposition path for that specific return should be something other than keep it (i.e., require the customer to return the item to receive a refund). Once the disposition path for the item is determined, the control circuit 302 transmits an indication of the disposition path to the user device 308.

The user device 308 can be of any suitable type, such as a general-purpose computer, a specific-purpose computer (e.g., a POS terminal), a mobile device (e.g., a mobile device), etc. Accordingly, the indication of the disposition path for the item can be transmitted to the customer and/or an employee of the retailer via the user device 308. For example, if a customer initiates a return via the user device 308 and the disposition path for the item is transmitted to the user device 308, the indication of the disposition path is transmitted to the customer. Alternatively, if the customer brings the item to a brick-and-mortar facility to return the item, the user device 308 may be a POS terminal and the indication of the disposition path is transmitted to the employee via the POS terminal.

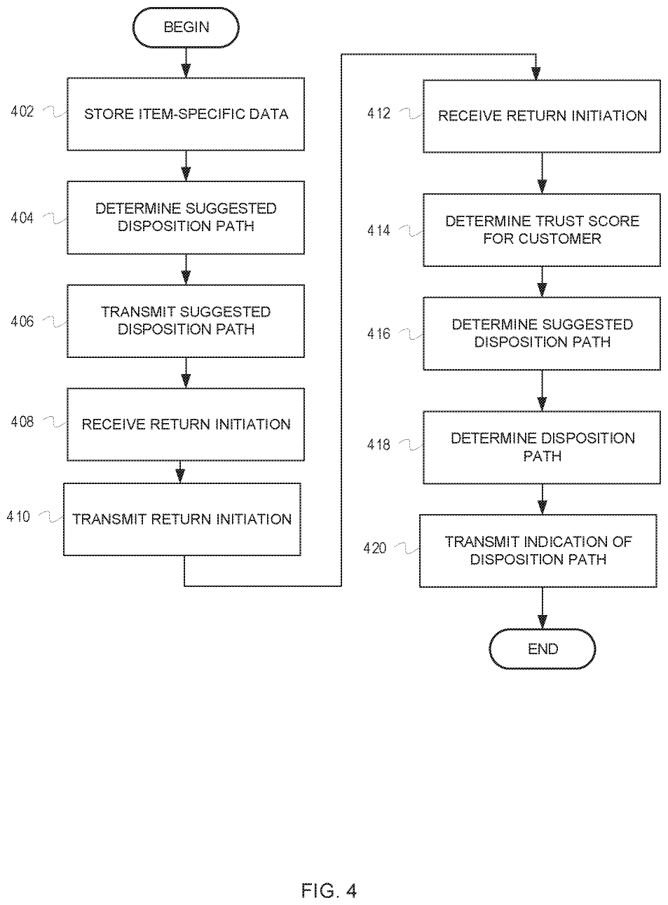

While the discussion of FIG. 3 provides additional detail regarding a system for determining a disposition path for a returned item, the discussion of FIG. 4 describes example operations for determining a disposition path for a returned item.

FIG. 4 is a flow chart including example operations for determining a disposition path for a returned item, according to some embodiments. The flow begins at block 402.

At block 402, item-specific data is stored. For example, a database can store the item specific data. The item-specific data includes reverse supply chain cost information for items. Additionally, in some embodiments, the database can also store customer data. The flow continues at block 404.

At block 404, a suggested disposition path is determined. For example, a control circuit can determine suggested disposition paths for items. In some embodiments, the control circuit determines suggested disposition paths for many, if not all, items that a retailer sells. The control circuit determines suggested disposition paths for items based on the item-specific data in the database. For example, the control circuit can determine the suggested disposition paths for the items based on calculations such as those discussed with respect FIG. 2. In some embodiments, the control circuit updates the suggested disposition paths for the items. For example, if the item-specific data for an item changes, the control circuit can update the suggested disposition path for the item based on the changed item-specific data. Additionally, or alternatively, the control circuit can update suggested disposition paths for items on a regular basis (e.g., daily, weekly, monthly, etc.). The flow continues at block 406.

At block 406, the suggested disposition paths are transmitted. For example, the control circuit can transmit the suggested disposition paths to the database for storage. The flow continues at block 408.

At block 408, a return initiation is received. For example, a user device can receive the return initiation. The user device can be a customer device or an employee device. As an example of a customer device, the user device can be a smartphone on which the customer initiates the return. As an example of an employee device, the user device can be a POS terminal and the employee can initiate the return via the POS terminal. In some embodiments, the return initiation includes an indication of item (i.e., the item(s) being returned) and/or an indication of a customer (i.e., the customer returning the item(s)). The flow continues at block 410.

At block 410, the return initiation is transmitted. For example, the user device can transmit the return initiation to the control circuit. The flow continues at block 412.

At block 412, the return initiation is received. For example, the control circuit can receive the return initiation from the user device. The flow continues at block 414.

At block 414, a trust score is determined for the customer. For example, the control circuit can determine the trust score for the customer. The control circuit can determine the trust score for the customer based on any suitable information. For example, the control circuit can determine the trust score based on the customer's shopping history, length of time the customer has been a member or otherwise shopped with the retailer, the customer's return and/or purchase history, etc. The flow continues at block 416.

At block 416, a suggested disposition path is determined. For example, the control circuit can determine the suggested disposition path. The control circuit can determine the suggested disposition path based on the indication of the item by accessing the database. The flow continues at block 418.

At block 418, a disposition path is determined. For example, the control circuit can determine the disposition path. The control circuit determines the disposition path based on the trust score for the customer and the suggested disposition path. It should be noted that in some embodiments, the trust score for the customer may not be considered. That is, the control circuit may determine the disposition path for the item by simply selecting the suggested disposition path. The flow continues at block 420.

At block 420, an indication of the disposition path is transmitted. For example, the control circuit can transmit the indication of the disposition path to the user device.

In some embodiments, a system for determining a disposition path for a return item comprises a database, wherein the database includes item-specific data for a plurality of items and customer data for a plurality of customers, wherein the item-specific data for a plurality of items includes reverse supply chain cost information and suggested disposition paths, and wherein the reverse supply chain cost information includes one or more of probability of resale, markdown for resale, retail price, cost of product, store handling cost, liquidation recovery, return center handling cost, store to return center transportation cost, margin, tax rate, other cost, cost of product, and customer service desk cost, a control circuit, wherein the control circuit is configured to determine, based on the reverse supply chain cost information, a suggested disposition path for each of the plurality of items, and transmit, to the database for storage, the suggested disposition path for each of the plurality of items, and a user device including a user input device, wherein the user device is configured to receive, via the user input device from a user, a return initiation, wherein the return initiation includes an indication of an item and an indication of a customer, and transmit, to the control circuit, the return initiation, wherein the control circuit is further configured to receive, from the user device, the return initiation, determine, based on the indication of the customer and the customer data for a plurality of customer, a trust score for the customer, determine, based on the indication of the item and the item-specific data, a suggested disposition path for the item, determine, based on the trust score for the customer and the suggested disposition path for the item, a disposition path for the item, and transmit an indication of the disposition path for the item.

In some embodiments, an apparatus and a corresponding method performed by the apparatus comprises storing, at a database, item-specific data for a plurality of items and customer data for a plurality of customers, wherein the item-specific data for a plurality of items includes reverse supply chain cost information and suggested disposition paths, and wherein the reverse supply chain cost information includes one or more of probability of resale, markdown for resale, retail price, cost of product, store handling cost, liquidation recovery, return center handling cost, store to return center transportation cost, margin, tax rate, other cost, cost of product, and customer service desk cost, determining, by a control circuit based on the reverse supply chain cost information, a suggested disposition path for each of the plurality of items, transmitting, to the database for storage, the suggested disposition path for each of the plurality of items, receiving, at a user input device of a user device, a return initiation, wherein the return initiation includes an indication of an item and an indication of a customer, transmitting, to the control circuit, the return initiation, receiving, at the control circuit from the user device, the return initiation, determining, based on the indication of the customer and the customer data for a plurality of customers, a trust score for the customer, determining, based on the indication of the item and the item-specific data for a plurality of items, a suggested disposition path for the item, determining, based on the trust score for the customer and the suggested disposition path for the item, a disposition path for the item, and transmitting an indication of the disposition path for the item.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for determining a disposition path for a returned item, the system comprising:
a database, wherein the database includes item-specific data for a plurality of items and customer data for a plurality of customers, wherein the item-specific data for a plurality of items includes reverse supply chain cost information and suggested disposition paths, and wherein the reverse supply chain cost information includes one or more of probability of resale, markdown for resale, retail price, cost of product, store handling cost, liquidation recovery, return center handling cost, store to return center transportation cost, margin, tax rate, other cost, cost of product, and customer service desk cost;
a control circuit, wherein the control circuit is configured to:
determine, based on the reverse supply chain cost information, a suggested disposition path for each of the plurality of items;
transmit, to the database for storage, the suggested disposition path for each of the plurality of items; and
a user device including a user input device, wherein the user device is configured to:
receive, via the user input device from a user, a return initiation, wherein the return initiation includes an indication of an item and an indication of a customer;
transmit, to the control circuit, the return initiation;
wherein the control circuit is further configured to:
receive, from the user device, the return initiation;
determine, based on the indication of the customer and the customer data for a plurality of customers, a trust score for the customer;
determine, based on the indication of the item and the item-specific data, a suggested disposition path for the item;
determine, based on the trust score for the customer and the suggested disposition path for the item, a disposition path for the item; and
transmit an indication of the disposition path for the item.

2. The system of claim 1, wherein the suggested disposition path for the item is keep it, and
if the trust score for the customer is above a threshold, the disposition path for the item is keep it, and
if the trust score for the customer is below the threshold, the disposition path for the item is return.

3. The system of claim 2, wherein the customer purchased the item at a brick-and-mortar facility.

4. The system of claim 1, wherein the suggested disposition paths include one or more of resell, liquidate, donate, destroy, and keep it, and wherein the suggested disposition path is chosen based on which of the one or more of resell, liquidate, donate, destroy, and keep has a highest value.

5. The system of claim 4, wherein,
resell value is calculated based on the probability of sale times the markdown for resell less the store handling cost;
liquidate value is calculated based on the liquidation recovery less return center handling cost, the store to return center transportation cost, the store handling cost, and the cost of product;
donate value is based the margin times a rate times the tax rate less the store handling cost and the product cost;
destroy value is based on the product cost less the store handling cost and other costs; and
keep it value is based on the product cost and the customer service desk cost.

6. The system of claim 1, wherein the control circuit determines the suggested path for each of the plurality of items on an item-by-item basis.

7. The system of claim 1, wherein the control circuit transmits the indication of the disposition path for the item to the user device.

8. The system of claim 7, wherein the user device is located in a brick-and-mortar retail facility, and wherein the user is a store employee.

9. The system of claim 1, wherein the user is the customer, and wherein the control circuit transmits the indication of the disposition path for the item to the user device.

10. The system of claim 1, wherein the control circuit periodically re-determines the suggested disposition path for at least some of the plurality of items.

11. A method for determining a disposition path for a returned item, the method comprising:
storing, at a database, item-specific data for a plurality of items and customer data for a plurality of customers, wherein the item-specific data for a plurality of items includes reverse supply chain cost information and suggested disposition paths, and wherein the reverse supply chain cost information includes one or more of probability of resale, markdown for resale, retail price, cost of product, store handling cost, liquidation recovery, return center handling cost, store to return center transportation cost, margin, tax rate, other cost, cost of product, and customer service desk cost;
determining, by a control circuit based on the reverse supply chain cost information, a suggested disposition path for each of the plurality of items;
transmitting, to the database for storage, the suggested disposition path for each of the plurality of items;
receiving, at a user input device of a user device, a return initiation, wherein the return initiation includes an indication of an item and an indication of a customer;
transmitting, to the control circuit, the return initiation;
receiving, at the control circuit from the user device, the return initiation;
determining, based on the indication of the customer and the customer data for a plurality of customers, a trust score for the customer;
determining, based on the indication of the item and the item-specific data for a plurality of items, a suggested disposition path for the item;
determining, based on the trust score for the customer and the suggested disposition path for the item, a disposition path for the item; and
transmitting an indication of the disposition path for the item.

12. The method of claim 11, wherein the suggested disposition path for the it is keep it, and
if the trust score for the customer is above a threshold, the disposition path for the item is keep it, and
if the trust score for the customer is below the threshold, the disposition path for the item is return.

13. The method of claim 12, wherein the customer purchased the item at a brick-and-mortar facility.

14. The method of claim 11, wherein the suggested disposition paths include one or more of resell, liquidate, donate, destroy, and keep it.

15. The method of claim 14, wherein,
resell value is calculated based on the probability of sale times the markdown for resell less the store handling cost;
liquidate value is calculated based on the liquidation recovery less return center handling cost, the store to return center transportation cost, the store handling cost, and the cost of product;
donate value is based the margin times a rate times the tax rate less the store handling cost and the product cost;
destroy value is based on the product cost less the store handling cost and other costs; and
keep it value is based on the product cost and the customer service desk cost.

16. The method of claim 11, the determining the suggested disposition path for each of the items is performed by the control circuit on an item-by-item basis.

17. The method of claim 11, wherein the control circuit transmits the indication of the disposition path for the item to the user device.

18. The method of claim 17, wherein the user device is located in a brick-and-mortar facility, and wherein the user is a store employee.

19. The method of claim 11, wherein the user is the customer, and wherein the control circuit transmits the indication of the disposition path for the item to the user device.

20. The method of claim 11, wherein the control circuit periodically re-determines the suggested disposition path for at least some of the plurality of items.
